(19) United States
(12) Patent Application Publication
(10) Pub. No.: US 2006/0242394 A1
(43) Pub. Date: Oct. 26, 2006

(54) Processor and processor instruction buffer operating method

(75) Inventor: Masato Uchiyama, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/211,459

(22) Filed: Aug. 26, 2005

(30) Foreign Application Priority Data
Apr. 26, 2005 (JP) 2005-128361

(51) Int. Cl. G06F 9/44

(52) U.S. Cl. 712/241

(57) ABSTRACT

A processor includes an instruction fetch unit providing a fetch address to the memory system; a branch buffer, a normal buffer, and a general buffer, which receive fetch instructions, respectively; a to-be-issued instruction selecting unit, which selects an instruction from the normal buffer, the branch buffer, and the general buffer and issues the instruction in conformity with an instruction from the instruction buffer control unit; an instruction decoding unit, which receives the instruction issued from the to-be-issued instruction selecting unit, decodes the issued instruction, and transmits decoded results to the instruction buffer control unit; a loop processing unit, which receives the decoded results from the instruction decoding unit and transmits a loop start address to the instruction fetch unit; and a branch determination unit, which transmits a fetch address to the instruction fetch unit established when a branching condition is satisfied or not satisfied.

### CROSS REFERENCE TO RELATED APPLICATIONS AND INCORPORATION BY REFERENCE

This application is based upon and claims the benefit of priority from prior Japanese Patent Application P2005-128361 filed on Apr. 26, 2005; the entire contents of which are incorporated by reference herein.

### BACKGROUND OF THE INVENTION

1. Field of the Invention

The present invention relates to a processor. More specifically, it relates to a processor, which carries out high speed branching and hardware-based loop processing using respective, exclusive instruction buffers, and a processor instruction buffer operating method.

2. Description of the Related Art

Processors developed in recent years often have an overhead of using multiple cycles for instruction fetch, even without bus accesses. Such processors offset such an instruction fetching overhead by collectively fetching a greater number of instructions than the number of instructions issued within each single cycle, retaining the remaining instructions in an instruction buffer, and issuing instructions one after another from the buffer.

Such processors are compatible with high-speed branching, which is achieved by utilizing the reserved fetching capability of such processors and thereby fetching and saving instructions in a buffer before determining whether or not an instruction of a branching target for a conditional/unconditional branch instruction or before determining whether or not a branching condition is satisfied. The reserved fetching capability of such processors is due to a fetching throughput that surpasses actually issued throughput (see, U.S. Pat. No. 5,579,493).

There are also processors capable of running loops in a program by having specific hardware retain the position of the end of an iteration process so as to automatically return present processing to the beginning of that iteration, instead of deploying a branch instruction at the end of the iteration process and returning present processing to the beginning of that iteration (see, U.S. Pat. No. 6,189,092, for example). Since such processors are capable of decreasing the overhead of branch instruction execution and branching, loops in a program can be run at a high speed.

When exclusive hardware carries out loop processing, an exclusive buffer retains all or part of the iteration to be repeatedly carried out and issues instructions from the exclusive buffer to decrease the overhead of fetching and storing instructions in an instruction memory (see, Japanese Patent Application Laid-open No. 2000-276351, for example).

Utilization of the two techniques for enhancing processor operating speed together with the exclusive buffer described above provides advantages of both technologies. However, this creates a problem that a buffer for loop processing may be infrequently used as opposed to a buffer for prefetching a branching target.

### SUMMARY OF THE INVENTION

An aspect of the present invention inheres in a processor which includes a memory system; an instruction fetch unit, which provides a fetch address to the memory system; a branch buffer, a normal buffer, and a general buffer, which receive fetch instructions from the memory system, respectively; an instruction buffer control unit, which controls the instruction fetch unit, the branch buffer, the normal buffer, and the general buffer; a to-be-issued instruction selecting unit, which selects an instruction from the normal buffer, the branch buffer, and the general buffer and issues the instruction in conformity with an instruction from the instruction buffer control unit; an instruction decoding unit, which receives the instruction issued from the to-be-issued instruction selecting unit, decodes the issued instruction, and transmits decoded results to the instruction buffer control unit; a loop processing unit, which receives the decoded results from the instruction decoding unit and transmits a loop start address to the instruction fetch unit; and a branch determination unit, which receives the decoded results from the instruction decoding unit and transmits a fetch address to the instruction fetch unit established when a branching condition is satisfied or not satisfied.

Another aspect of the present invention inheres in a processor instruction buffer operating method, which includes selecting, by a to-be-issued instruction selecting unit, an instruction from a normal buffer and a branch buffer and issuing the instruction in conformity with an instruction from an instruction buffer control unit; determining whether a branching condition for an instruction issued by a branch determination unit is satisfied; clearing the branch buffer by the instruction buffer control unit when the branching condition is not satisfied; specifying an address to be issued next by the instruction buffer control unit as a branching target address when the branching condition is satisfied; determining, by the instruction buffer control unit, whether there is an instruction in the branch buffer; and copying and moving the content of the branch buffer to the normal buffer in conformity with an instruction from the instruction buffer control unit, and at the same time selecting, by the to-be-issued selecting unit, an instruction from the branch buffer and issuing the instruction in conformity with an instruction from the instruction buffer control unit when the branching condition is satisfied.

Another aspect of the present invention inheres in a processor instruction buffer operating method, which includes selecting, by a to-be-issued instruction selecting unit, an instruction from a normal buffer and a loop buffer and issuing the instruction in conformity with an instruction from an instruction buffer control unit; determining whether an instruction issued by a loop processing unit is a loop start instruction; determining whether the loop processing unit initiates jumping from the tail end of a loop to the beginning thereof and a looping condition is satisfied when the branching condition is not satisfied; jumping to the beginning of the loop and specifying an address to be issued next by the instruction buffer control unit as the loop start address when the branching condition is satisfied; and copying the content of the loop buffer and storing the content in the normal buffer in conformity with an instruction from the instruction buffer control unit, and at the same time selecting, by the to-be-issued selecting unit, an instruction from the loop buffer and issuing the instruction in conformity with an instruction from the instruction buffer control unit.

### BRIEF DESCRIPTION OF DRAWINGS

FIG. 1 is a schematic block diagram of a processor according to a first embodiment of the present invention;

FIG. 2 is a schematic block diagram showing a basic structure of the processor according to the first embodiment of the present invention;

FIG. 3 is a state machine state transition diagram showing an operation of the basic structure of the processor according to the first embodiment of the present invention;

FIG. 4 is a schematic block diagram dedicated to a branch system of the processor according to the first embodiment of the present invention;

FIG. 5 is a state machine state transition diagram dedicated to a fetch system of the processor, according to the first embodiment of the present invention, for high speed branching;

FIG. 6 is a flowchart dedicated to an issuing system of the processor, according to the first embodiment of the present invention, for high speed branching;

FIG. 7 is a schematic block diagram dedicated to a loop system of the processor, according to the first embodiment of the present invention;

FIG. 8 is a state machine state transition diagram dedicated to a fetch system of the processor, according to the first embodiment of the present invention, for loop processing;

FIG. 9 is a flowchart dedicated to an issuing system of the processor, according to the first embodiment of the present invention, for loop processing;

FIG. 10 is a schematic block diagram showing a loop processing unit applied to the processor according to the first embodiment of the present invention;

FIG. 11 shows a program in which only an end can be specified according to the processor of the first embodiment of the present invention;

FIG. 12 shows a program in which both a beginning and an end can be specified according to the processor of the first embodiment of the present invention;

FIG. 13 shows a program for a processor according to the first embodiment of the present invention;

FIG. 14 is a state machine state transition diagram dedicated to a fetch system of the processor, according to the first embodiment of the present invention, using a method of forming nested branches;

FIG. 15 is a flowchart dedicated to an issuing system of the processor, according to the embodiment of the present invention, using a method of forming nested branches;

FIG. 16 is a state machine state transition diagram dedicated to a fetch system the processor, according to the embodiment of the present invention, using a method of preparing for when a branching condition is not satisfied; and

FIG. 17 is a flowchart dedicated to an issuing system of the processor, according to the embodiment of the present invention, using a method of preparing for when a branching condition is not satisfied.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Referring to the drawings, embodiments of the present invention are described below. The embodiments shown below exemplify an apparatus and a method that are used to implement the technical ideas according to the present invention, and do not limit the technical ideas according to the present invention to those that appear below. These technical ideas, according to the present invention, may receive a variety of modifications that fall within the claims.

According to an embodiment of the present, a processor which uses exclusive instruction buffers to carry out high speed branching and hardware-based loop processing, respectively, and a processor instruction buffer operating method, improvement in rate of utilization of a loop buffer and high speed branching are possible.

A processor according to an embodiment of the present invention uses exclusive instruction buffers to carry out high speed branching and hardware-based loop processing, respectively, and has either a structure including those of a branch buffer and a loop buffer or a structure including a loop buffer with the same structure as a branch buffer, which allows use of the loop buffer for prefetching a second branching target while not running a loop.

### First Embodiment

(Entire Block Structure)

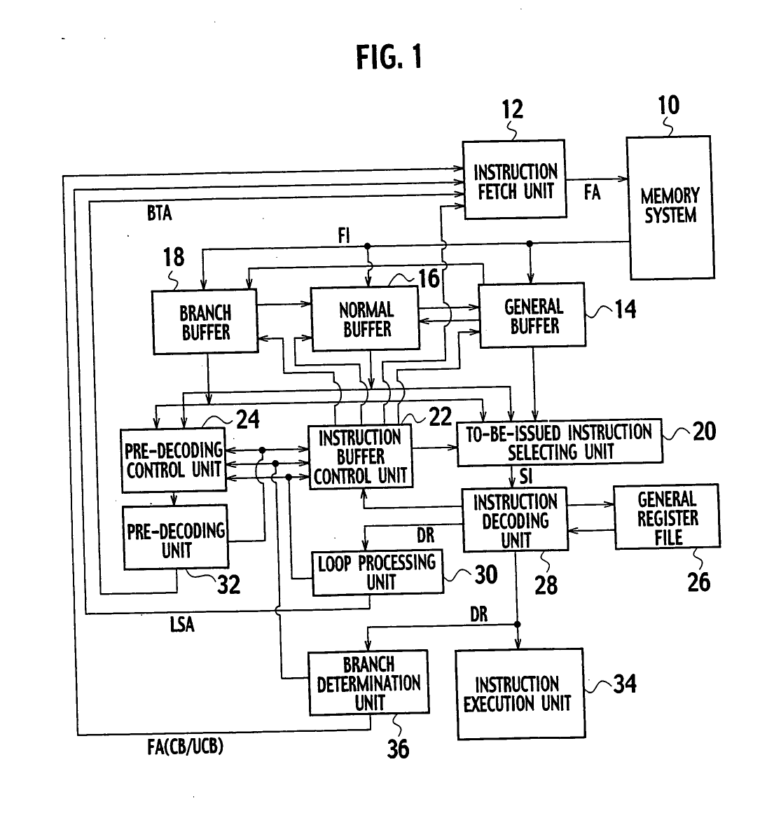

A processor according to a first embodiment of the present invention includes a memory system 10; an instruction fetch unit 12 providing a fetch address FA to the memory system 10; a branch buffer 18, a normal buffer 16 and a general buffer 14, which receive fetch instructions FI from the memory system 10, respectively; and an instruction buffer control unit 22 for controlling the instruction fetch unit 12, the branch buffer 18, the normal buffer 16, and the general buffer 14. The processor further comprises a to-be-issued instruction selecting unit 20 connected to the instruction buffer control unit 22 and also connected to the branch buffer 18, the normal buffer 16, and the general buffer 14; a pre-decoding control unit 24 connected to the instruction buffer control unit 22 and also connected to the normal buffer 16 and the branch buffer 18; and an instruction decoding unit 28 receiving an instruction SI issued from the to-be-issued instruction selecting unit 20 and then transmits decoding results DR to the instruction buffer control unit 22. The processor also includes a general register file 26 connected to the instruction decoding unit 28 and from which a loop count or the like is read out when executing a loop instruction; a pre-decoding unit 32 connected to the pre-decoding control unit 24 and transmits a branching target address BTA to the instruction fetch unit 12; a loop processing unit 30 receiving decoding results DR from the instruction decoding unit 28 and then transmits a loop start address LSA to the instruction fetch unit 12; a branch determination unit 36 receiving the decoding results DR from the instruction decoding unit 28 and transmits a fetch address FA to the instruction fetch unit 12 generated when a branching condition is satisfied or not satisfied (CB/UCB); and an instruction execution unit 34 receiving the decoding results DR from the instruction decoding unit 28, as shown in FIG. 1.

-Instruction Buffer Operating Method-

An instruction buffer operating method for the processor, according to the first embodiment of the present invention, is as described forthwith.

(a) Instruction fetch is carried out when there is a vacancy in the branch buffer 18, the normal buffer 16, and the general buffer 14.

(b) Instruction issuance is carried out when there is an instruction to be issued in either of the branch buffer 18, the normal buffer 16, or the general buffer 14.

(c) When there are instructions in the normal buffer 16, those instructions are pre-decoded to detect a branch instruction. If a branch instruction allowing prefetching of a branching target is detected, an instruction of that branching target is then prefetched and stored in the branch buffer 18.

(d) If a branching condition is satisfied and there is an instruction in the branch buffer 18, that instruction is moved to the normal buffer 16.

(e) If the branching condition is satisfied and there is an instruction of a nested branching target address in the general buffer 14, that instruction is moved to the branch buffer 18.

(f) If the branching condition is satisfied and the general buffer 14 includes an instruction in the branching target address corresponding to the branch instruction in a branching target address resulting from the branching condition being satisfied, that instruction is cleared.

(g) Otherwise, If the branching condition is not satisfied, the branch buffer 18 is cleared and pre-decoding of the content of the normal buffer 16 resumes.

(h) If the branching condition is not satisfied and the general buffer 14 includes an instruction in the branching target address corresponding to the branch instruction in a branching target address resulting from the branching condition being satisfied, that instruction is cleared.

(i) If the branching condition is not satisfied and the general buffer 14 includes an instruction in a nested branching target address, that instruction is moved to the branch buffer 18.

(j) If there is a vacancy in the general buffer 14 after execution of a loop instruction, a fetched instruction is then stored in the normal buffer 16 and the general buffer 14.

(k) When executing the loop instruction, an instruction in the normal buffer 16 is copied and stored in the general buffer 14.

(l) The branch buffer 18 is cleared at a time of loop processing.

(m) Case A: if a loop is not being run, there is an instruction in the branch buffer 18, and there are no instructions in the general buffer 14. Alternatively, there is a loop starting instruction. The instruction in the branch buffer 18 is then pre-decoded to detect a branch instruction. If a branch instruction is detected, the content of the general buffer 14 is then prefetched.

(n) Case B: if a loop is not being run, there is an instruction in the branch buffer 18, and there are no instructions in the general buffer 14. Alternatively, there is a loop starting instruction, the instruction in the branch buffer 16 that is a branching target of ‘a branch instruction having the branching target prefetched and stored in the branch buffer 18’ is then pre-decoded to detect a branch instruction. If a branch instruction is detected, the content of the general buffer 14 is then prefetched.

(Basic Structure)

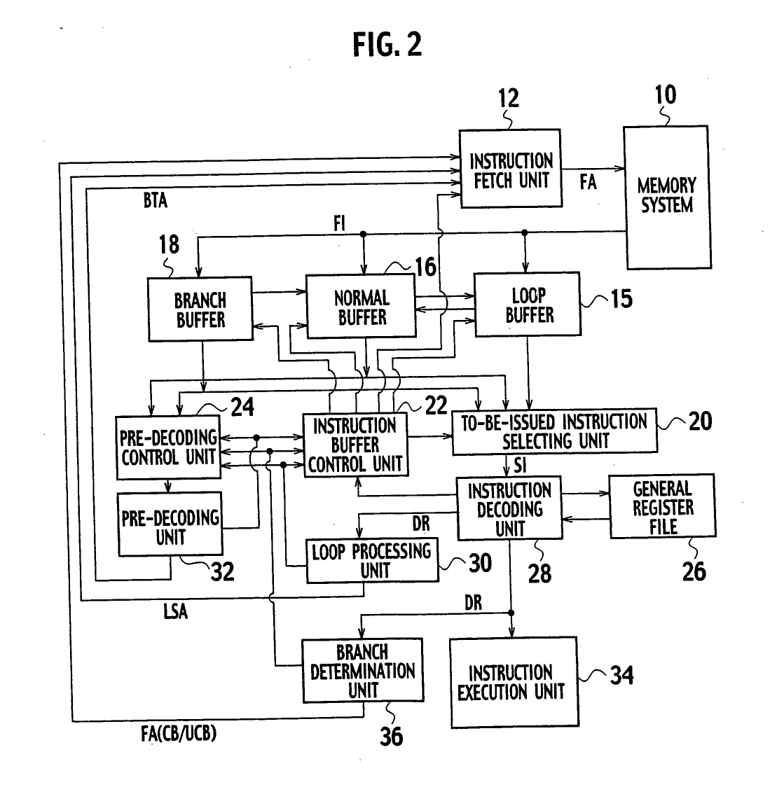

The basic structure of the processor according to the first embodiment of the present invention is shown in FIG. 2 and includes the memory system 10, the instruction fetch unit 12, which provides a fetch address FA to the memory system 10; a loop buffer 15, the normal buffer 16 and the branch buffer 18 receiving fetch instructions FI from the memory system 10, respectively; and an instruction buffer control unit 22 controlling the instruction fetch unit 12, the loop buffer 15, the normal buffer 16, and the branch buffer 18. The processor further includes the to-be-issued instruction selecting unit 20 connected to the instruction buffer control unit 22 and also connected to the loop buffer 15, the normal buffer 16 and the branch buffer 18; the pre-decoding control unit 24 connected to the instruction buffer control unit 22 and also connected to the normal buffer 16 and the branch buffer 18; the instruction decoding unit 28 receiving an instruction issued from the to-be-issued instruction selecting unit 20 and then transmits decoding results DR to the instruction buffer control unit 22; and a general register file 26, connected to the instruction decoding unit 28 and from which a loop count or the like is read out when executing a loop instruction. Also included in the processor is a pre-decoding unit 32 connected to the pre-decoding control unit 24 and transmits a branching target address BTA to the instruction fetch unit 12; a loop processing unit 30 receiving decoding results DR from the instruction decoding unit 28 and then transmits a loop start address LSA to the instruction fetch unit 12; a branch determination unit 36 receiving the decoding results DR from the instruction decoding unit 28 and transmits a fetch address FA to the instruction fetch unit 12 established when a branching condition is satisfied or not satisfied (CB/UCB); and an instruction execution unit 34 receiving the decoding results DR from the instruction decoding unit 28.

-Instruction Buffer Operating Method for Basic Structure-

An instruction buffer operating method for the basic structure of the processor according to the first embodiment of the present invention is as described forthwith.

(a) Instruction fetch is carried out when there is a vacancy in the branch buffer 18 and the normal buffer 16.

(b) Instruction issuance is carried out when there is an instruction to be issued in either of the branch buffer 18, the normal buffer 16, or the loop buffer 15.

(c) When there are instructions in the normal buffer 16, those instructions are pre-decoded to detect a branch instruction. If a branch instruction allowing prefetching of a branching target is detected, an instruction of that branching target is then prefetched and stored in the branch buffer 18.

(d) If a branching condition is satisfied and there is an instruction in the branch buffer 18, that instruction is moved to the normal buffer 16.

(e) Otherwise, If the branching condition is not satisfied, the branch buffer 18 is cleared and pre-decoding of the content of the normal buffer 16 resumes.

(f) If there is a vacancy in the loop buffer 15 after execution of a loop instruction, a fetched instruction is then stored in the normal buffer 16 and the loop buffer 15.

(g) When executing the loop instruction, an instruction in the normal buffer 16 is copied and stored in the loop buffer 15.

(h) The branch buffer 18 is cleared at a time of loop processing.

-Behavior Analysis of Basic Structure Based on State Machine State Transition-

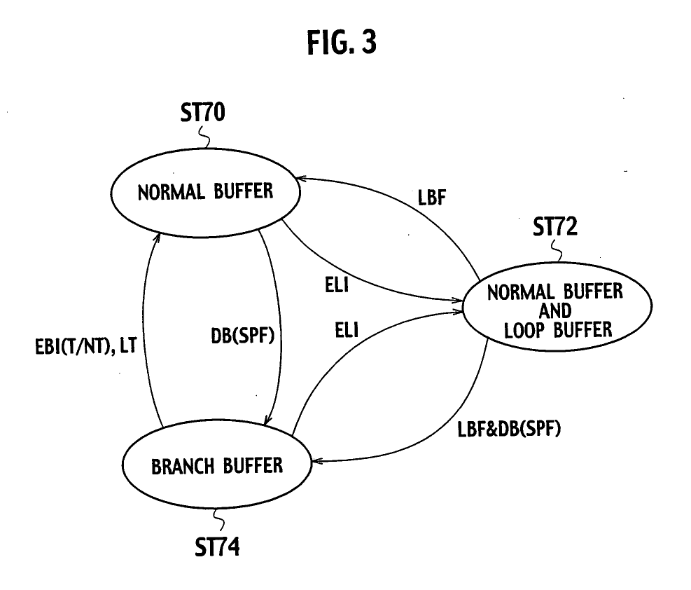

Instruction fetch behavior according to the basic structure is shown in a state machine state transition diagram of FIG. 3.

(a) When a branch is detected (DB: Detect Branch) and prefetching resumes (SPF: Start Prefetch), a state machine state ST70 in which fetching and storing in the normal buffer 16 is carried out changes to a state ST74 in which fetching and storing in the branch buffer 18 is carried out.

(b) The branch determination unit 36 determines whether or not a branching condition is satisfied or whether or not a branch is taken (T/NT: Taken/Not Taken). The branch determination unit 36 then allows either execution of a branch instruction (EBI: Execute Branch Instruction) or the loop processing unit 30 to initiate jumping from the tail end of a loop to the beginning thereof or taking a loop (LT: Loop Taken). When this determination is made, the state ST74 in which fetching and storing in the branch buffer 18 is carried out changes to the state ST70 in which fetching and storing in the normal buffer 16 is carried out.

(c) When a loop instruction is executed (ELI: Execute Loop Instruction), the state ST70 in which fetching and storing in the normal buffer 16 is carried out changes to a state ST72 in which fetching and storing in the normal buffer 16 and the loop buffer 15 is carried out.

(d) In the case of the loop buffer being full (LBF: Loop Buffer Full), the state ST72 in which fetching and storing in the normal buffer 16 and the loop buffer 15 is carried out changes to the state ST70 in which fetching and storing in the normal buffer 16 is carried out.

(e) When a loop instruction is executed (ELI), the state ST74 in which fetching and storing in the branch buffer 18 is carried out changes to the state ST72 in which fetching and storing in the normal buffer 16 and the loop buffer 15 is carried out.

(f) When the loop buffer is full (LBF) and a branch is detected (DB) and prefetching starts (SPF: Start Prefetch), the state ST72 in which fetching and storing in the normal buffer 16 and loop buffer 15 is carried out changes to the state ST74 in which fetching and storing in the branch buffer 18 is carried out.

(Structure of Branching System)

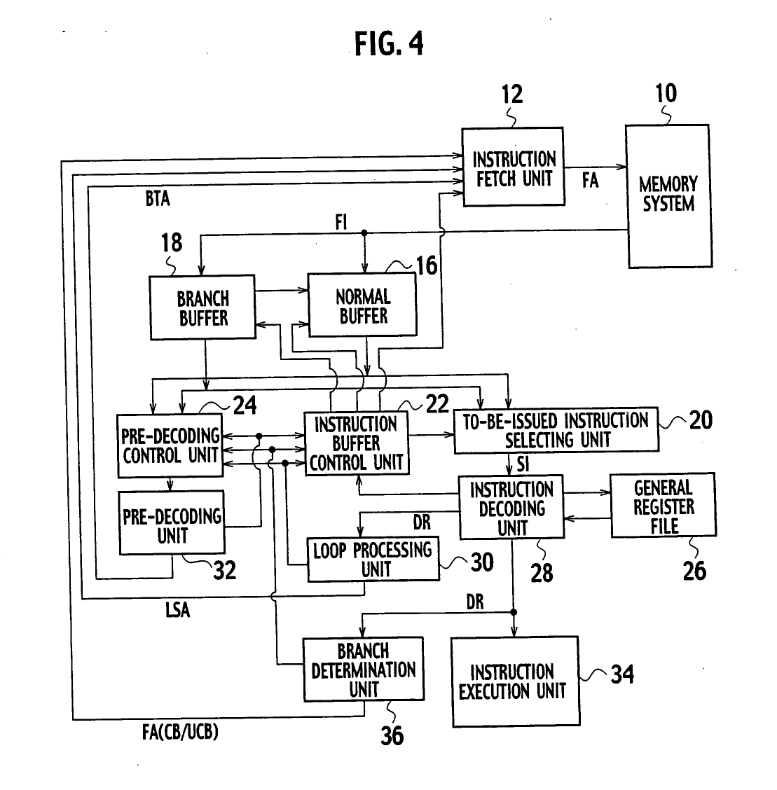

A structure of a branching system of the processor according to the first embodiment of the present invention is shown in FIG. 4 and includes the memory system 10; the instruction fetch unit 12 providing a fetch address FA to the memory system 10; the normal buffer 16 and the branch buffer 18 receiving fetch instructions FI from the memory system 10, respectively; the instruction buffer control unit 22 controlling the instruction fetch unit 12, the normal buffer 16, and the branch buffer 18; and the to-be-issued instruction selecting unit 20, connected to the instruction buffer control unit 22 and also connected to the normal buffer 16 and the branch buffer 18. The branching system structure further includes the pre-decoding control unit 24 connected to the instruction buffer control unit 22 and also connected to the normal buffer 16 and the branch buffer 18; the instruction decoding unit 28, receiving a to-be-issued instruction SI from the to-be-issued instruction selecting unit 20 and then transmits decoding results DR to the instruction buffer control unit 22; the general register file 26 connected to the instruction decoding unit 28 and from which a loop count or the like is read out when executing a loop instruction; the pre-decoding unit 32 connected to the pre-decoding control unit 24 and transmits a branching target address BTA to the instruction fetch unit 12; the loop processing unit 30 receiving decoding results DR from the instruction decoding unit 28 and then transmits a loop start address LSA to the instruction fetch unit 12; a branch determination unit 36 receiving the decoding results DR from the instruction decoding unit 28 and transmits a fetch address FA to the instruction fetch unit 12 established when a branching condition is satisfied or not satisfied (CB/UCB); and the instruction execution unit 34 receiving the decoding results DR from the instruction decoding unit 28.

-Instruction Buffer Operating Method for Branching System-

An instruction buffer operating method for a branching system of the processor according to the first embodiment of the present invention is as described forthwith.

(a) Instruction fetch is carried out when there is a vacancy in the normal buffer 16 and the branch buffer 18.

(b) Instruction issuance is carried out when there is an instruction to be issued in either the normal buffer 16 or the branch buffer 18.

(c) When there are instructions in the normal buffer 16, those instructions are pre-decoded to detect a branch instruction. If a branch instruction allowing prefetching of a branching target is detected, an instruction of that branching target is then prefetched and stored in the branch buffer 18.

(d) If a branching condition is satisfied and there is an instruction in the branch buffer 18, that instruction is moved to the normal buffer 16.

(e) Otherwise, if the branching condition is not satisfied, the branch buffer 18 is cleared and pre-decoding the content of the normal buffer 16 resumes.

(f) When returning to the beginning of a loop, the branch buffer 18 is cleared and pre-decoding starts again from the beginning of the loop.

(Exemplary High-Speed Branching)

Exemplary high-speed branching by the processor according to the first embodiment of the present invention is descried forthwith.

(a) Instructions retained in the normal buffer 16 are scanned and pre-decoded to detect a branch instruction that allows determination of a branching target at a time of pre-decoding.

(b) An instruction of the branching target determined through pre-decoding is fetched and stored in the branch buffer 18, which is used for retaining a branching target.

(c) If a branching condition is satisfied, the content of the branch buffer 18 is copied and stored in the normal buffer 16, and issuance of an instruction of the branching target starts without an overhead of fetching the instruction of the branching target.

If the branching condition is not satisfied, the content of the branch buffer 18 is discarded.

-Behavior Analysis of Fetch System Based on State Machine State Transition-

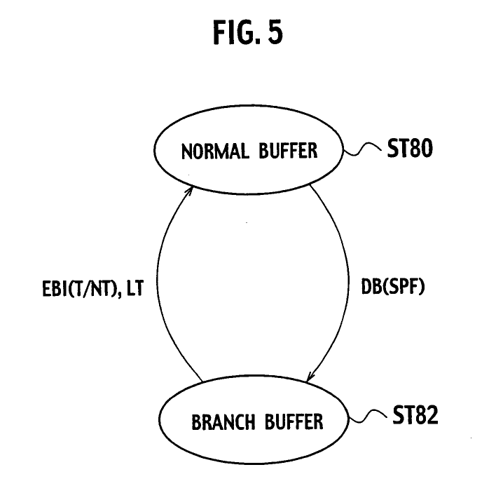

The behavior of a fetch system of the processor according to the first embodiment of the present invention for high-speed branching is shown in a state machine transition state diagram of FIG. 5.

(a) When a branch is detected (DB) and prefetching starts (SPF), a state machine state ST80 in which fetching and storing in the normal buffer 16 is carried out changes to a state ST82 in which fetching and storing in the branch buffer 18 is carried out.

(b) When the branch determination unit 36 determines whether or not a branching condition is satisfied and allows either execution of a branch instruction (EBI) or the loop processing unit 30 to initiate jumping from the tail end of a loop to the beginning thereof (LT), the state ST82 in which fetching and storing in the branch buffer 18 is carried out changes to the state ST80 in which fetching and storing in the normal buffer 16 is carried out.

-Flowchart Showing Behavior of Issuance System-

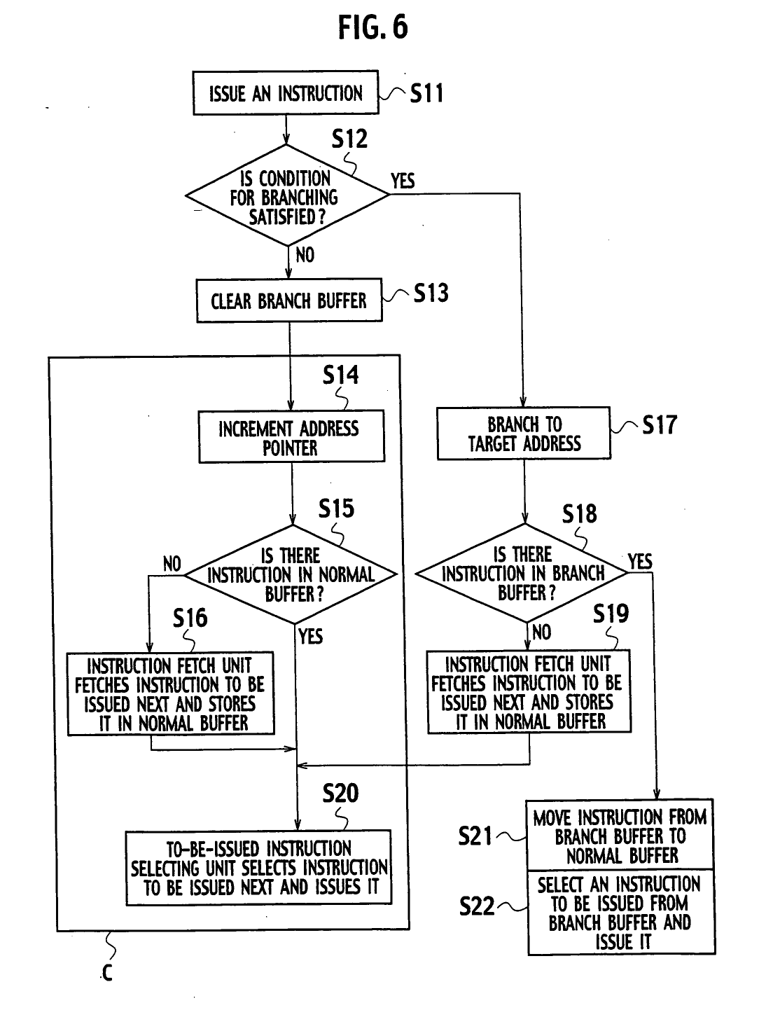

The behavior of an issuing system of the processor according to the first embodiment of the present invention for high-speed branching is shown in a flowchart of FIG. 6.

(a) As pre-processing, the to-be-issued instruction selecting unit 20 selects a single instruction from the normal buffer 16 and the branch buffer 18 and then issues the instruction in conformity with an instruction from the instruction buffer control unit 22 in step S11.

(b) Next, in step S12, the branch determination unit 36 determines whether or not a branching condition for the issued instruction is satisfied.

(c) If the answer is NO in the step S12, processing proceeds to step S13 in which the instruction buffer control unit 22 then clears the branch buffer 18.

(d) Next, in step S14, the instruction buffer control unit 22 increments the address to be issued next (i.e., program counter PC). Processing then proceeds to step S15.

(e) In the step S15, the instruction buffer control unit 22 determines whether or not an instruction to be issued next exists in the normal buffer 16.

(f) If the answer is NO in the step S15, processing proceeds to step S16 in which the instruction fetch unit 12 then fetches an instruction to be issued next from the memory system 10 and stores the instruction in the normal buffer 16 in conformity with an instruction from the instruction buffer control unit 22. Processing then proceeds to step S20.

(g) If the answer is YES in the step S15, processing proceeds to step S20 in which the to-be-issued instruction selecting unit 20 then selects an instruction from the normal buffer 16 and issues the instruction in conformity with an instruction from the instruction buffer control unit 22.

(h) If the answer is YES in the step S12, processing proceeds to step S17 in which the instruction buffer control unit 22 then specifies the address to be issued next (i.e., program counter PC) as a branching target address. The branching target address is sent from the instruction decoding unit 28.

(i) Next, in step S18, the instruction buffer control unit 22 determines whether or not there is an instruction in the branch buffer 18.

(j) If the answer is NO in the step S18, processing proceeds to step S19 in which the instruction fetch unit 12 then fetches an instruction in a branching target address from the memory system 10 and stores the instruction in the normal buffer 16 in conformity with an instruction from the instruction buffer control unit 22. Processing then proceeds to step S20. The branching target address is sent from the branch determination unit 36 to the instruction fetch unit 12.

(k) If the answer is YES in the step S18, processing proceeds to step S21 in which the content of the branch buffer 18 is then copied and moved to the normal buffer 16 in conformity with an instruction from the instruction buffer control unit 22.

(l) At the same time, in step S22, the to-be-issued instruction selecting unit 20 selects an instruction from the branch buffer 18 and issues the instruction in conformity with an instruction from the instruction buffer control unit 22.

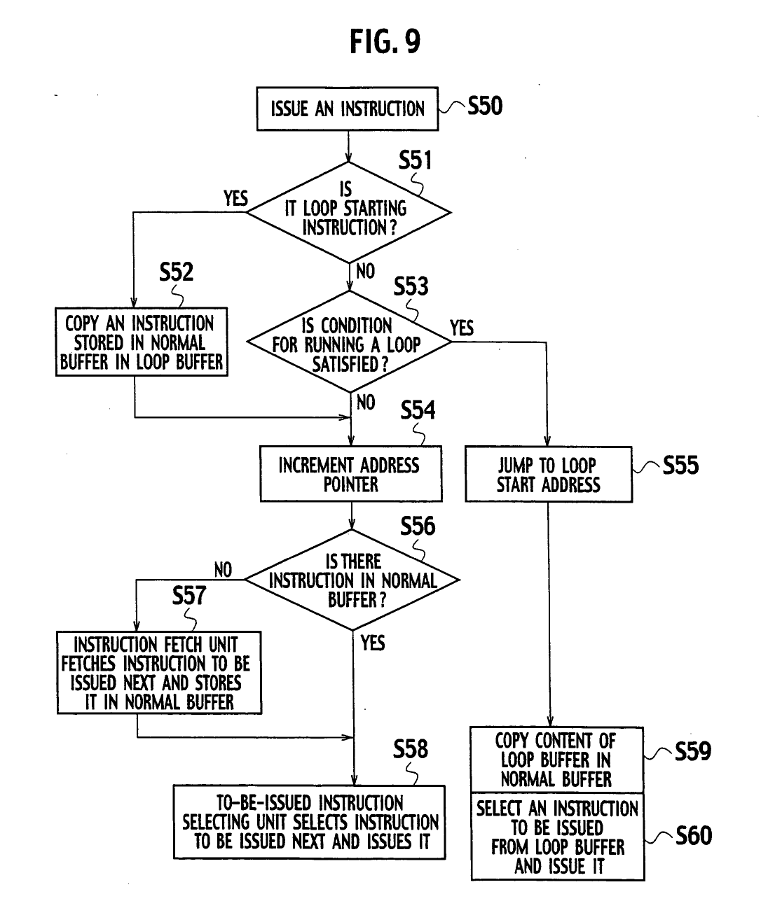

Processing in the steps S14 through S16 and step S20 of FIG. 6 enclosed by the area designated C is the same as that for instructions other than branch instructions. The processing is also similar to processing in step S54 and steps S56 through S58 of FIG. 9, which is a flowchart for loop processing described later.

(Loop Processing System Structure)

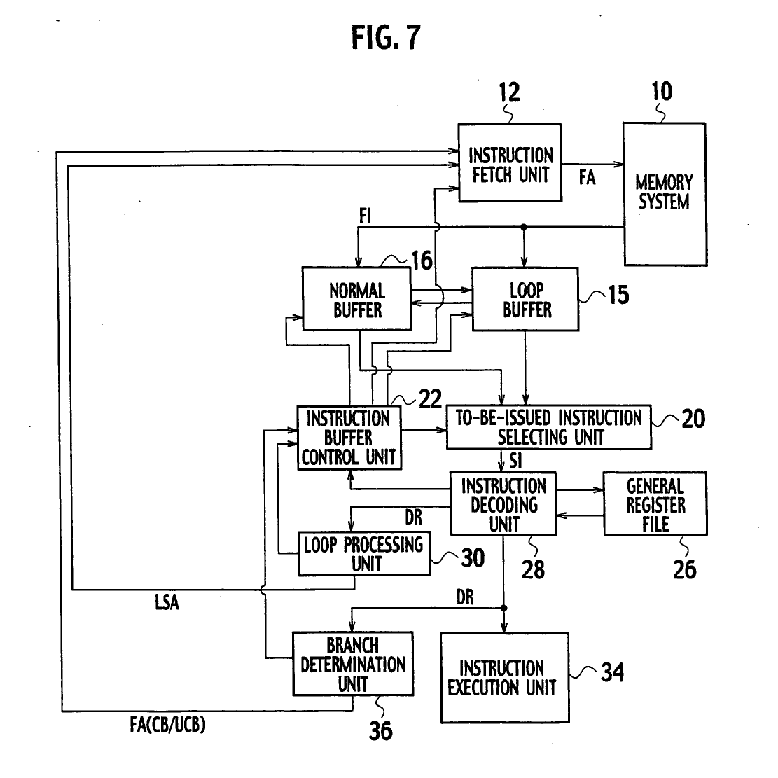

A loop processing system structure of the processor according to the first embodiment of the present invention is shown in FIG. 7 and includes the memory system 10; the instruction fetch unit 12, which provides a fetch address FA to the memory system 10; the loop buffer 15 and the normal buffer 16, which receive fetch instructions FI from the memory system 10, respectively; the instruction buffer control unit 22, which controls the instruction fetch unit 12, the loop buffer 15, and the normal buffer 16; the to-be-issued instruction selecting unit 20 connected to the instruction buffer control unit 22 and also connected to the loop buffer 15 and the normal buffer 16; the instruction decoding unit 28, which receives an instruction SI issued from the to-be-issued instruction selecting unit 20 and then transmits decoding results DR to the instruction buffer control unit 22; the general register file 26 connected to the instruction decoding unit 28 and from which a loop count or the like is read out when executing a loop instruction; the loop processing unit 30, which receives decoding results DR from the instruction decoding unit 28 and then transmits a loop start address LSA to the instruction fetch unit 12; the branch determination unit 36, which receives the decoding results DR from the instruction decoding unit 28 and transmits a fetch address FA to the instruction fetch unit 12 established when a branching condition is satisfied or not satisfied (CB/UCB); and the instruction execution unit 34, which receives the decoding results DR from the instruction decoding unit 28.

-Instruction Buffer Operating Method for Loop Processing System-

An instruction buffer operating method for a loop processing system of the processor according to the first embodiment of the present invention is as described forthwith.

(a) Instruction fetch is carried out when there is a vacancy in the normal buffer 16.

(b) If there is a vacancy in the loop buffer 15 after execution of a loop instruction, a fetched instruction is then stored in the normal buffer 16 and the loop buffer 15.

(c) Instruction issuance is carried out when there is an instruction to be issued in either the normal buffer 16 or the loop buffer 15. By returning to the beginning of the loop, this phrase means there is an instruction in the loop buffer 15.

(d) When executing the loop instruction, an instruction in the normal buffer 16 is copied and stored in the loop buffer 15.

(e) If a branching condition is satisfied, the normal buffer 16 is cleared and fetching from a branching target restarts.

(Exemplary Loop Processing)

Exemplary loop processing by the processor according to the first embodiment of the present invention is described forthwith.

(a) When executing an instruction for loop setting, an instruction at the beginning of a loop, which should be stored in the normal buffer 16, is copied and stored in the loop buffer 15, which is used for retaining a loop block.

(b) Upon issuance of instructions until the loop end, the content of the loop buffer 15 is copied and stored in the normal buffer 16, and issuing an instruction at the beginning of the loop starts without an overhead of fetching instructions.

-Behavior Analysis of Loop System Based on State Machine State Transition-

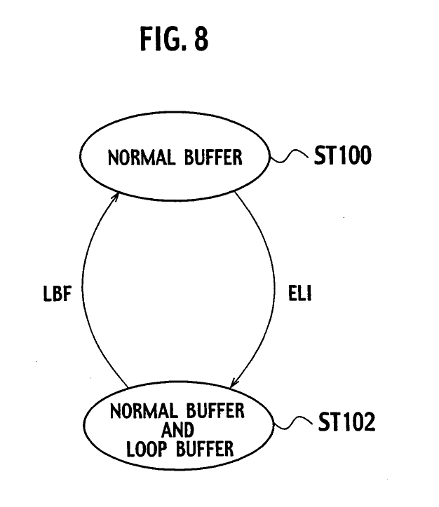

The behavior of a fetch system of the processor according to the first embodiment of the present invention for loop processing is shown in a state machine transition state diagram of FIG. 8.

(a) When a loop instruction is executed (ELI), a state ST100 in which fetching and storing in the normal buffer 16 is carried out changes to a state ST102 in which fetching and storing in the normal buffer 16 and the loop buffer 15 is carried out.

(b) In the case of the loop buffer being full (LBF), the state ST102 in which fetching and storing in the normal buffer 16 and the loop buffer 15 is carried out changes to the state ST100 in which fetching and storing in the normal buffer 16 is carried out.

-Flowchart Showing Behavior of Issuing System-

The behavior of an issuing system of the processor, according to the first embodiment of the present invention, for loop processing is shown in a flowchart of FIG. 9.

(a) As pre-processing, the to-be-issued instruction selecting unit 20 selects a single instruction from the normal buffer 16 and the branch buffer 15 and then issues the instruction in conformity with an instruction from the instruction buffer control unit 22 in step S50.

(b) Next, in step S51, the loop processing unit 30 determines whether or not the issued instruction is a loop starting instruction.

(c) Next, if the answer is YES in the step S51, processing proceeds to step S52 in which an instruction in the normal buffer 16 is then copied and stored in the loop buffer 15 in conformity with an instruction from the instruction buffer control unit 22. Processing then proceeds to step S54.

(d) If the answer is NO in the step S51, processing proceeds to step S53.

(e) Next, in the step S53, the loop processing unit 30 determines whether or not jumping from the tail end of the loop to the beginning thereof will be allowed or a looping condition is satisfied.

(f) If the answer is YES in the step S53, processing proceeds to step S55 in which jumping to the loop start address is then carried out. In other words, the instruction buffer control unit 22 specifies an address to be issued next (i.e., program counter PC) as a loop start address; where the loop start address is sent from the loop processing unit 30.

(g) If the answer is NO in the step S53, processing proceeds to step S54 in which the instruction buffer control unit 22 then increments the address to be issued next (i.e., program counter PC).

(h) Next, in step S56, the instruction buffer control unit 22 determines whether or not an instruction to be issued next exists in the normal buffer 16.

(i) If the answer is NO in the step S56, processing proceeds to step S57 in which the instruction fetch unit 12 then fetches an instruction to be issued next from the memory system 10 and stores the instruction in the normal buffer 16 in conformity with an instruction from the instruction buffer control unit 22. Processing then proceeds to step S58.

(j) If the answer is YES in the step S56, processing proceeds to step S58 in which the to-be-issued instruction selecting unit 20 then selects an instruction from the normal buffer 16 and issues the instruction in conformity with an instruction from the instruction buffer control unit 22.

(k) In step S59 after the step S55, the content of the loop buffer 15 is copied and stored in the normal buffer 16 in conformity with an instruction from the instruction buffer control unit 22.

(l) At the same time, in step S60, the to-be-issued instruction selecting unit 20 selects an instruction from the loop buffer 15 and issues the instruction in conformity with an instruction from the instruction buffer control unit 22.

(Loop Processing Unit)

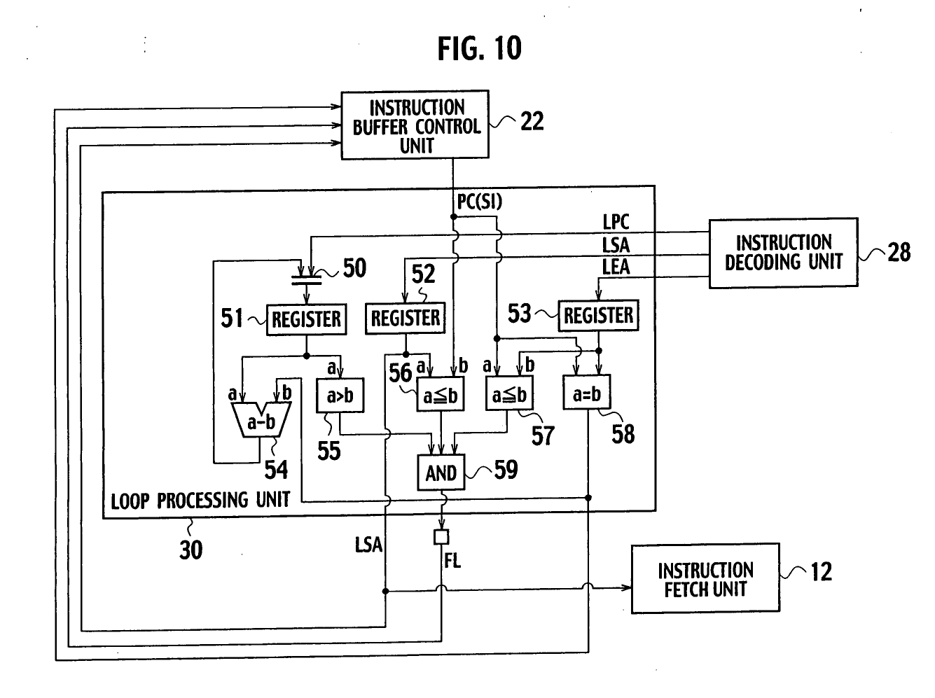

The loop processing unit 30 of the processor according to the first embodiment of the present invention is shown in FIG. 10 and comprises a selector 50, which selects either a loop count LPC sent from the instruction decoding unit 28 or the output from a subtracter 54; a register 51 connected to the selector 50 which retains a remaining loop count; a register 52, which receives a loop start address LSA from the instruction decoding unit 28; a register 53, which receives a loop end address LEA from the instruction decoding unit 28; the subtracter 54, which calculates the difference between the output of a resistor 51 and the output of a comparator 58; a comparator 55 connected to the register 51; a comparator 56, which compares the output from the register 52 with the program counter PC (SI) for an instruction SI issued from the instruction buffer control unit 22; comparators 57 and 58, each comparing the output from the register 53 with the program counter PC (SI) for the instruction SI issued from the instruction buffer control unit 22; and an AND gate 59 connected to the comparators 55, 56 and 57.

The subtracter 54 decrements the loop count LPC at the loop end.

The loop start address LSA, which is an output signal from the register 52, is sent to the instruction fetch unit 12 as well as the instruction buffer control unit 22. The AND gate 59 determines that the loop is running when the following three conditions are satisfied. The three conditions are: (i) Remaining loop count LPC is one or greater than one, (ii) Program counter PC is equal to or greater than the loop start address LSA, and (iii) Program counter PC is equal to or less than the loop end address LEA.

The output of the AND gate 59 is sent to the instruction buffer control unit 22 via a looping flag (FL) buffer.

(Exemplary Loop Program)

A program for copying 32-byte data in address 0x1000 and then storing the data in address 0x2000 is described forthwith. The 32 byte data corresponds to four-byte (lw/sw) word access that is carried out eight-times. Note that ‘0x’ denotes a hexadecimal digit. An exemplary C language program is given as:

for (i=0;i<8;i++) {b[i]=a[i];}

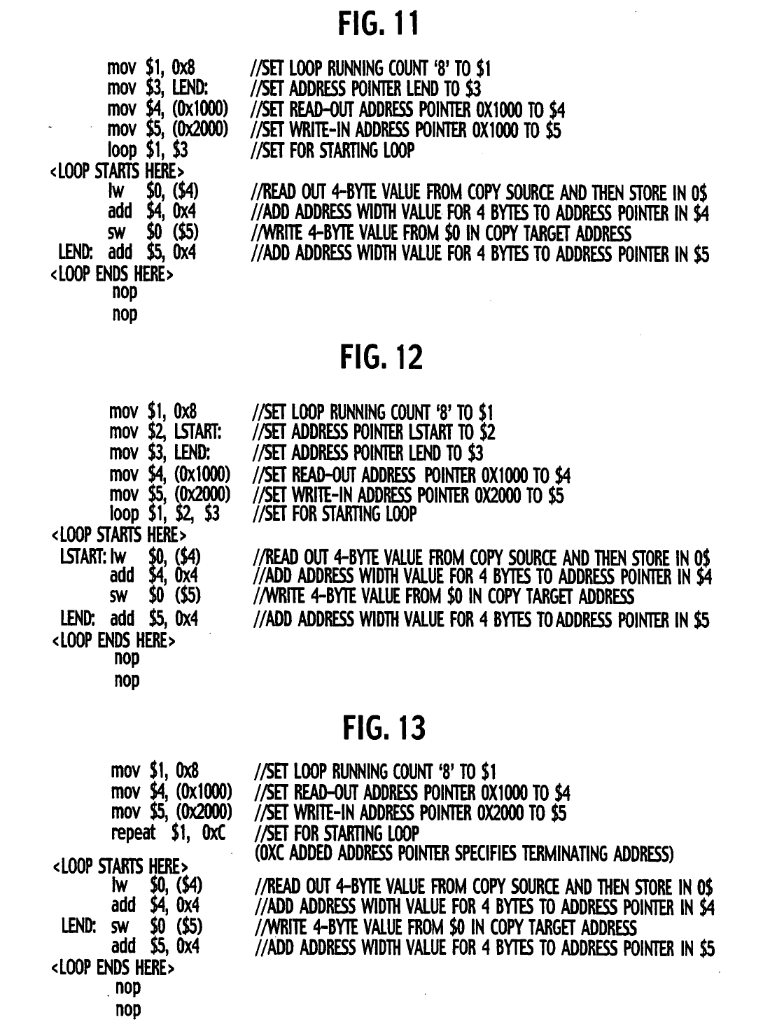

FIG. 11 shows a program for a processor according to the first embodiment of the present invention that specifies only an end of the loop; $1 denotes the first register in the general register file 26.

FIG. 12 shows a program for a processor according to the first embodiment of the present invention that specifies both a beginning and an end of the loop.

FIG. 13 shows a program for a processor according to the first embodiment of the present invention.

(Method Using Loop Buffer for Prefetching a Branching Target)

Methods for the processor, according to the first embodiment, using a loop buffer 15 as a general buffer 14 for prefetching a branching target while not carrying out loop processing include (A) a method forming nested branches and (B) a method that preparing for a branching condition that is not being satisfied. These methods are described in detail forthwith.

(A) Method of Forming Nested Branches

An instruction sequence of a branching target is pre-decoded, and when a branch instruction is identified, a branching target for the instruction is prefetched. This process conceals branching latency developed due to a branch instruction of a branching target being pre-decoded and prefetched late in the case of the branch instruction existing just after the first branch instruction is prefetched.

-Exemplary Program List for Forming Nested Branches-

An exemplary program list for forming nested branches is shown below.

nop

(a) bnez $1, A ←prefetch and store in branch buffer 18

nop

(b) beqz $2, B ←do not prefetch

nop

A: nop

(c) bra $3, C: ←prefetch and store in general buffer 14

nop

A branching target (a) fetched and stored in the branch buffer 18 is pre-decoded, and when a branch is identified (c), prefetching a branching target (c) and storing the target in the general buffer 14 are carried out. Branching latency developed when there is a branch instruction in a branching target address for a branching instruction (a) immediately after a branching condition is satisfied can be decreased.

-Behavior Analysis of Fetch System Based on State Machine State Transition-

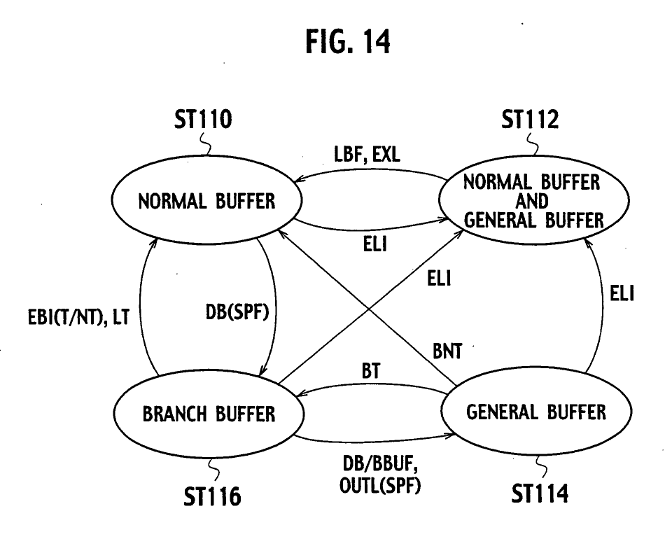

The behavior of a fetch system using a method of forming nested branches is shown in a state machine state transition diagram of FIG. 14.

(a) When a branch is detected (DB) and prefetching starts (SPF), a state machine state ST110 in which fetching and storing in the normal buffer 16 is carried out changes to a state ST116 in which fetching and storing in the branch buffer 18 is carried out.

(b) When the branch determination unit 36 determines whether or not a branching condition is satisfied and then allows either execution of a branch instruction (EBI) or the loop processing unit 30 to initiate jumping from the tail end of a loop to the beginning thereof (LT), the state ST116 in which fetching and storing in the branch buffer 18 is carried out changes to the state ST110 in which fetching and storing in the normal buffer 16 is carried out.

(c) When a loop instruction is executed (ELI), the state ST110 in which fetching and storing in the normal buffer 16 is carried out changes to a state ST112 in which fetching and storing in the normal buffer 16 and the general buffer 14 is carried out.

(d) In the case of the loop buffer being full (LBF) or exiting a loop (EXL: Exit Loop), the state ST112 in which fetching and storing in the normal buffer 16 and the loop buffer 14 is carried out changes to the state ST110 in which fetching and storing in the normal buffer 16 is carried out.

(e) When a loop instruction is executed (ELI), the state ST116 in which fetching and storing in the branch buffer 18 is carried out changes to the state ST112 in which fetching and storing in the normal buffer 16 and the general buffer 14 is carried out.

(f) When a branch is detected in the branch buffer (BBUF) 18 (DB), processing breaks out of the loop (OUTL: Out of Loop), and prefetching then starts (SPF). The state ST116 in which fetching and storing in the branch buffer 18 is carried out changes to the state ST114 in which fetching and storing in the general buffer 14 is carried out.

(g) When a loop instruction is executed (ELI) in the state ST114 in which fetching and storing in the general buffer 14 is carried out, the state ST114 in which fetching and storing in the general buffer 14 is carried out changes to the state ST112 in which fetching and storing in the normal buffer 16 and the general buffer 14 is carried out.

(h) When a branching condition is satisfied or a branch is taken (BT: Branch Taken) in the state ST114 in which fetching and storing in the general buffer 14 is carried out, the state ST114 in which fetching and storing in the general buffer 14 is carried out changes to the state ST116 in which fetching and storing in the branch buffer 18 is carried out.

(i) Otherwise, when the branching condition is not satisfied or the branch is not taken (BNT: Branch Not Taken) in the state ST114 in which fetching and storing in the general buffer 14 is carried out, the state ST114 in which fetching and storing in the general buffer 14 is carried out changes to the state ST110 in which fetching and storing in the normal buffer 16 is carried out.

At a point when a loop instruction is executed (ELI) in any state, the present state changes to the state ST112 in which fetching and storing in the normal buffer 16 and the general buffer 14 is carried out.

When a branch instruction is identified through pre-decoding, even while a loop is running, prefetching and storing in the branch buffer 18 can start. In other words, the state ST110 in which fetching and storing in the normal buffer 16 is carried out changes to the state ST116 in which fetching and storing in the branch buffer 18 is carried out.

When using the general buffer 14 for prefetching the second branching target in the state ST114 in which fetching and storing in the general buffer 14 is carried out, the looping flag of the loop processing unit 30 is checked (see FL in FIG. 10.)

-Flowchart Showing Behavior of Issuing System-

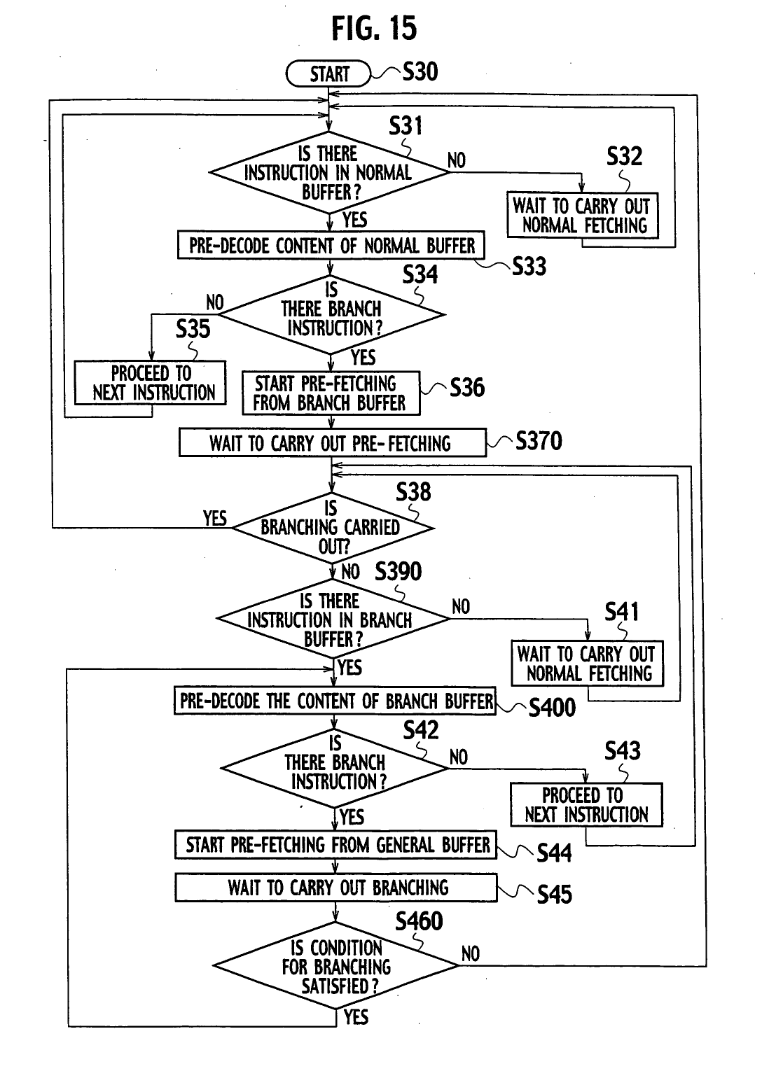

The behavior of an issuing system using a method of forming nested branches is shown in a flowchart of FIG. 15.

(a) In step S30, processing starts.

(b) In step S31, whether or not there is an instruction in the normal buffer 16 is determined.

(c) If the answer is NO in the step S31, processing proceeds to step S32 in which the processing waits to carry out normal fetching. Processing then returns to the step S31.

(d) If the answer is YES in the step S31, processing proceeds to step S33 in which pre-decoding the content of the normal buffer 16 is then carried out.

(e) Next, processing proceeds to step S34 in which a determination is made whether or not there is a branch instruction.

(f) If the answer is NO in the step S34, preparation for the next instruction is made in step S35. Processing then returns to the step S31.

(g) If the answer is YES in the step S34, prefetching the content of the branch buffer 18 starts in step S36.

(h) Next, in step S370, processing waits for prefetching.

(i) In step S38, whether or not branching is carried out is determined.

(j) If the answer is YES in the step S38, processing returns to the step S31.

(k) If the answer is NO in the step S38, processing proceeds to S390.

(l) In step S390, whether or not there is a branch instruction in the branch buffer 18 is determined.

(m) If the answer is NO in the step S390, the processing will wait to carry out normal fetch in step S41. Processing then returns to the step S38.

(n) If the answer is YES in the step S390, the content of the branch buffer 18 is pre-decoded in step S400.

(o) In step S42, whether or not there is a branch instruction is determined.

(p) If the answer is NO in the step S42, processing proceeds to step S43 in which preparation for the next instruction is then made. Processing then returns to the step S38.

(q) If the answer is YES in the step S42, processing proceeds to step S44 in which prefetching the content of the general buffer 14 starts.

(r) Next, processing proceeds to step S45 to wait to execute a branch instruction.

(s) In step S460, whether or not a branching condition is satisfied is determined.

(t) If the answer is NO in the step S460, processing returns to the step S31. In other words, when the branch determination unit 36 determines that a branching condition is not satisfied (BNT), the present processing target changes from the general buffer 14 to the normal buffer 16.

(u) If the answer is YES in the step S460, the present processing target changes from the general buffer 14 to the branch buffer 18. Processing then returns to the step S400. In other words, when the branch determination unit 36 determines that the branching condition is satisfied (BT), the present processing target changes from the general buffer 14 to the branch buffer 18. When using the general buffer 14 for prefetching the second branching target, the looping flag FL of the loop processing unit 30 is checked (see FIG. 10).

Steps S30 through S38 of FIG. 15 correspond to prefetching using the branch buffer 18. On the other hand, steps S390 through S460 correspond to prefetching using the branch buffer 14.

According to a method of forming nested branches in the processor of the first embodiment of the present invention prefetches a branching target using a loop buffer 15 as the general buffer 14 while not carrying out loop processing. The loop buffer can be used as the second branch buffer at a time other than when a loop is running. In other words, the loop buffer may be used for prefetching the second branching target while not carrying out loop processing.

(B) Method of Preparing for when Branching Condition is not Satisfied

A method of forming nested branches, which allows the processor to prefetch a branching target using the loop buffer 15 as the general buffer 14 while not carrying out loop processing, includes a method of preparing for when a branching condition is not satisfied. In other words, a sequence of instructions (a sequence of instructions just after a prefetched branch instruction) that should be executed if a branching condition for the prefetched branch instruction is not satisfied are pre-decoded. If a branch instruction is identified, its branching target is then prefetched. This process conceals branching latency developed due to a branch instruction of the second branching target being pre-decoded and prefetched late when branching instructions are successive and the branching target of the first branch instruction is prefetched but the branching condition is not satisfied.

-Exemplary Program List for Preparation of when Branching Condition is not Satisfied-

An exemplary program list for preparing for when a branching condition is not satisfied is as follows.

nop

(a) bnez $1, A ←prefetch and store in branch buffer 18

nop

(b) bnez $2, B ←prefetch and store in general buffer 14

nop

A: nop

(c) bra $3, C: ←do not prefetch

nop

Even after a branch instruction (a) is identified by pre-decoding the content of the normal buffer 16 and thereby starting prefetching, an instruction preceding the instruction (a) in the normal buffer 16 is further pre-decoded. At this time, if an instruction (b) is identified, a branching target of the branch instruction (b) is prefetched and stored in the general buffer 14 as compensation for the branching condition for the branch instruction (a) not being satisfied.

-Behavior Analysis of Fetch System Based on State Machine State Transition-

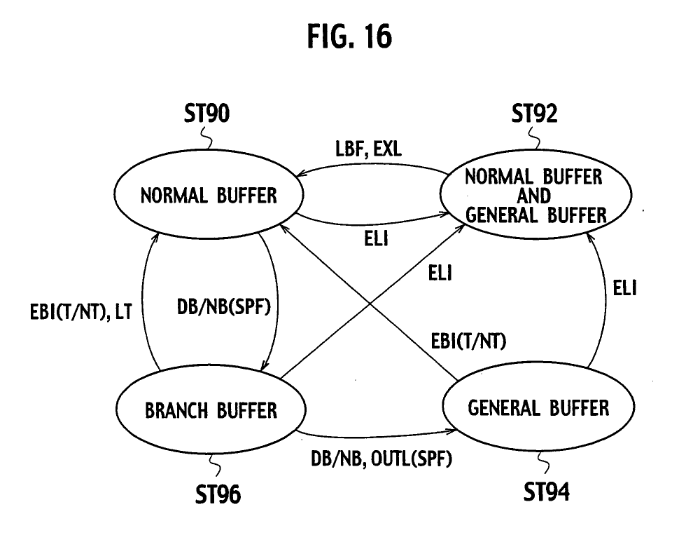

A behavior of a fetch system using a method of preparing for when a branching condition is not satisfied is shown in a state machine state transition diagram of FIG. 16.

(a) When a branch is detected in the normal buffer (NB) 16 (DB) and prefetching starts (SPF), a state ST90 in which fetching and storing in the normal buffer 16 is carried out changes to a state ST96 in which fetching and storing in the branch buffer 18 is carried out.

(b) When the branch determination unit 36 determines whether or not a branching condition is satisfied (T/NT) and either a branch instruction is executed (EBI) or the loop processing unit 30 initiates jumping from the tail end of the loop to the beginning thereof (LT), the state ST96 in which fetching and storing in the branch buffer 18 is carried out changes to the state ST90 in which fetching and storing in the normal buffer 16 is carried out.

(c) When a loop instruction is executed (ELI), the state ST90 in which fetching and storing in the normal buffer 16 is carried out changes to the state ST92 in which fetching and storing in the normal buffer 16 and the general buffer 14 is carried out.

(d) When the loop buffer is full (LBF) or exiting the loop (EXL), the state ST92 in which fetching and storing in the normal buffer 16 and the general buffer 14 is carried out changes to the state ST90 in which fetching and storing in the normal buffer 16 is carried out.

(e) When a loop instruction is executed (ELI), the state ST96 in which fetching and storing in the branch buffer 18 is carried out changes to the state ST92 in which fetching and storing in the normal buffer 16 and the general buffer 14 is carried out.

(f) When a branch is detected in the normal buffer (NB) 16 (DB), processing breaks out of the loop (OUTL), and prefetching starts (SPF). The state ST96 in which fetching and storing in the branch buffer 18 is carried out changes to a state ST94 in which fetching and storing in the general buffer 14 is carried out.

(g) When a loop instruction is executed (ELI) in the state ST94 in which fetching and storing in the general buffer 14 is carried out, the state ST94 changes to the state ST92 in which fetching and storing in the normal buffer 16 and the general buffer 14 is carried out.

(h) When a branch instruction is executed (EBI) in the state ST94 in which fetching and storing in the general buffer 14 is carried out regardless of the results of the branch determination unit 36 determining whether or not a branching condition is satisfied (T/NT), the state ST94 changes to the state ST90 in which fetching and storing in the normal buffer 16 is carried out.

In any state, at the point when a loop instruction is executed (ELI), the present state changes to the state ST92 in which fetching and storing in the normal buffer 16 and the general buffer 14 is carried out.

When a branch instruction is identified through pre-decoding, even while a loop is running, prefetching the content of the branch buffer 18 may start. In other words, the state ST90 in which fetching and storing in the normal buffer 16 is carried out changes to the state ST96 in which fetching and storing in the branch buffer 18 is carried out.

When the general buffer 14 is used for prefetching a branch target of a branch instruction, which is to be executed when a branching condition is not satisfied, in the state ST94 in which fetching and storing in the general buffer 14 is carried out, the looping flag FL (see FIG. 10) of the loop processing unit 30 is then checked.

-Flowchart Showing Behavior of Issuing System-

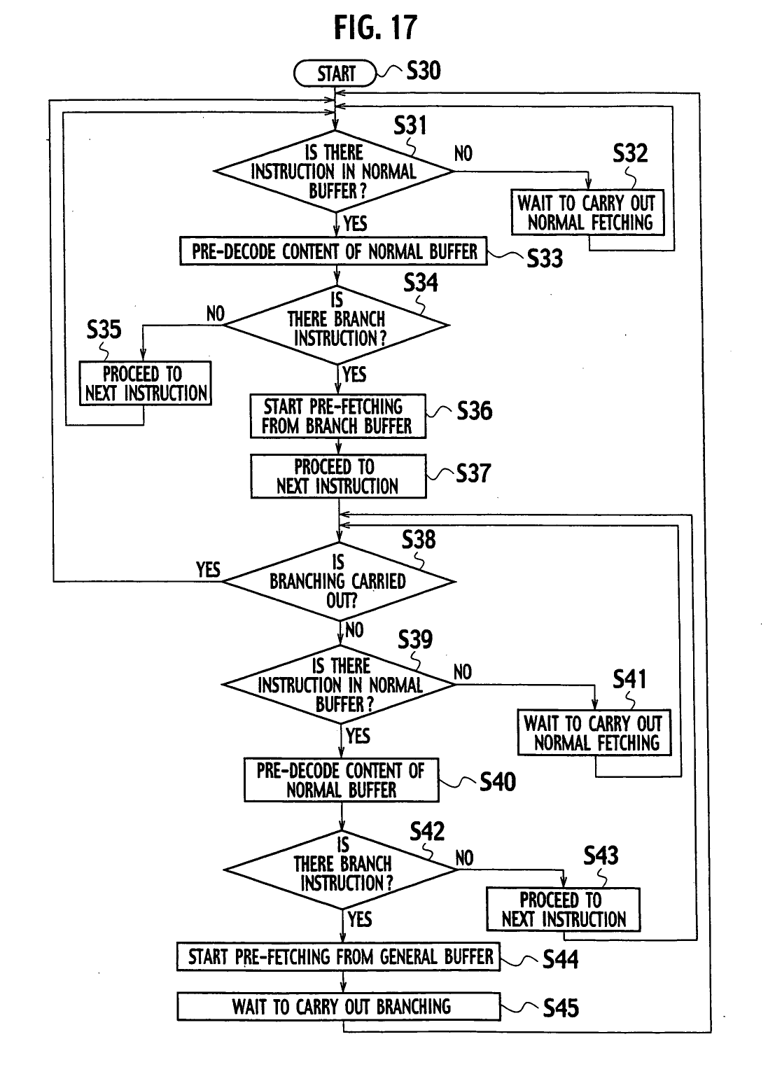

FIG. 17 is a flowchart showing a behavior of an issuing system according to a method of preparing for when a branching condition is not satisfied.

(a) In step S30, processing starts.

(b) In step S31, whether or not there is an instruction in the normal buffer 16 is determined.

(c) If the answer is NO in the step S31, processing proceeds to step S32 in which the processing waits to carry out normal fetch. Processing then returns to the step S31.

(d) If the answer is YES in the step S31, processing proceeds to step S33 in which pre-decoding the content of the normal buffer 16 is then carried out.

(e) Processing proceeds to step S34, in which, whether or not there is an instruction is then determined.

(f) If the answer is NO in the step S34, preparation for the next instruction is made in step S35. Processing then returns to the step S31.

(g) If the answer is YES in the step S34, prefetching the content of the branch buffer 18 is then carried out in step 36.

(h) In step S37, preparation for the next instruction is made.

(i) Next, in step S38, whether or not branching is carried out is determined.

(j) If the answer is YES in the step S38, processing returns to the step S31.

(k) If the answer is NO in the step S38, processing proceeds to step S39.

(l) Next, in the step S39, whether or not there is an instruction in the normal buffer 16 is determined.

(m) If the answer is NO in the step S39, processing waits to carry out normal fetch in step S41. Processing then returns to the step S38.

(n) If the answer is YES in the step S39, pre-decoding the content of the normal buffer 16 is then carried out in step S40.

(o) Next, in step S42, whether or not there is a branch instruction is determined.

(p) If the answer is NO in the step S42, processing proceeds to step S43 in which preparation for the next instruction is then made. Processing then returns to the step S38.

(q) If the answer is YES in the step S42, processing proceeds to step S44 in which prefetching the content of the general buffer 14 then starts.

(r) Next, processing proceeds to step S45 in which the processing waits to execute a branch instruction. Processing then returns to the step S31. In other words, when a branch instruction is executed (EBI) regardless of the results of the branch determination unit 36 determining whether or not a branching condition is satisfied (T/NT) the present processing target changes from the general buffer 14 to the normal buffer 16.

Steps S30 through S38 of FIG. 17 correspond to prefetching using the branch buffer 18. On the other hand, steps S39 through S45 correspond to prefetching using the general buffer 14.

When a branching condition is not satisfied, the present method allows the processor to prefetch a branching target using a loop buffer 15. A sequence of instructions (a sequence of instructions just after a prefetched branch instruction) that should be executed, if a branching condition for the prefetched branch instruction is not satisfied, are pre-decoded. Further, if a branch instruction is identified, its branching target is then prefetched. This process conceals branching latency developed due to the second branch instruction being pre-decoded and prefetched late when branching instructions are successive and a branching target of the first branch instruction is prefetched but a branching condition is not satisfied.

The processor of an embodiment of the present invention uses exclusive instruction buffers to carry out high speed branching and hardware-based loop processing, respectively. The processor instruction buffer operating method utilizes a processor including either a structure of the branch buffer 18 for branching and the general buffer 14 for loops or the general buffer 14 having the same structure as the branch buffer 18. Thus, use of the general buffer 14 for prefetching the second branch target while not carrying out loop processing is possible, which improves the rate of utilization of the general buffer 14 and high speed branching.

### Other Embodiments

While the present invention is described in accordance with the aforementioned embodiments, it should not be understood that the description and drawings that configure part of this disclosure are to limit the present invention. This disclosure makes clear a variety of alternative embodiments, working examples, and operational techniques for those skilled in the art. Accordingly, the technical scope of the present invention is defined by only the claims that appear appropriate from the above explanation.

Various modifications will become possible for those skilled in the art after receiving the teachings of the present disclosure without departing from the scope thereof.

What is claimed is:

1. A processor comprising:
a memory system;
an instruction fetch unit, which provides a fetch address to the memory system;
a branch buffer, a normal buffer, and a general buffer, which receive fetch instructions from the memory system, respectively;
an instruction buffer control unit, which controls the instruction fetch unit, the branch buffer, the normal buffer, and the general buffer;
a to-be-issued instruction selecting unit, which selects an instruction from the normal buffer, the branch buffer, and the general buffer and issues the instruction in conformity with an instruction from the instruction buffer control unit;
an instruction decoding unit, which receives the instruction issued from the to-be-issued instruction selecting unit, decodes the issued instruction, and transmits decoded results to the instruction buffer control unit;
a loop processing unit, which receives the decoded results from the instruction decoding unit and transmits a loop start address to the instruction fetch unit; and
a branch determination unit, which receives the decoded results from the instruction decoding unit and transmits a fetch address to the instruction fetch unit established when a branching condition is satisfied or not satisfied.

2. The processor of claim 1, further comprising: a pre-decoding control unit, connected to the instruction buffer control unit and also connected to the normal buffer and the branch buffer.

3. The processor of claim 1, further comprising a general register file connected to the instruction decoding unit to read out a loop count or the like when executing a loop instruction.

4. The processor of claim 2, further comprising a pre-decoding unit connected to the pre-decoding control unit and which transmits a branching target address to the instruction fetch unit.

5. The processor of claim 1, further comprising an instruction execution unit, which receives decoding results from the instruction decoding unit.

6. The processor of claim 1, wherein an instruction in the normal buffer is pre-decoded, and an instruction of a determined branching target is prefetched and stored in the branch buffer; and, when a target branching condition is satisfied, the branch buffer issues an instruction of a branching target and the content of the branch buffer is copied and stored in the normal buffer, and when the target branching condition is not satisfied, the content of the branch buffer is discarded.

7. The processor of claim 1, wherein an instruction at the beginning of a loop and subsequent instructions are stored in the general buffer when running the loop; when loop processing starts, and the general buffer issues the instruction at the beginning of the loop and at the beginning of the subsequent instructions, while when loop processing has not started, the general buffer is used for prefetching the second branching target.

8. The processor of claim 1, wherein the loop processing unit comprises:
a selector, which selects one of the loop count sent from the instruction decoding unit or the output of a subtracter;
a register connected to the selector and which retains a remaining loop count;
a second register, which receives a loop start address from the instruction decoding unit;
a third register, which receives a loop end address from the instruction decoding unit;
the subtracter, which calculates the difference between output of the register and output of a first comparator;
a second comparator connected to the register;
a third comparator, which compares the output of the second register and a program counter for an instruction issued from the instruction buffer control unit;
a fourth comparator, which compares the output of the third register and the program counter for the instruction issued from the instruction buffer control unit with the first comparator; and
an AND gate connected to the second, third and fourth comparators.

9. The processor of claim 8, wherein the subtracter decrements the loop count at the end of the loop.

10. The processor of claim 8, wherein the loop start address, which is an output signal from the second register, is sent to the instruction fetch unit as well as the instruction buffer control unit.

11. The processor of claim 8, wherein the AND gate determines that a loop is running when three conditions: (i) the remaining loop count is one or greater than one, (ii) the program counter is equal to or greater than the loop start address, and (iii) the program counter is equal to or less than the loop end address, are satisfied.

12. The processor of claim 8, wherein the output of the AND gate is sent to the instruction buffer control unit via a looping flag buffer.

13. A processor instruction buffer operating method, comprising:
selecting, by a to-be-issued instruction selecting unit, an instruction from a normal buffer and a branch buffer and issuing the instruction in conformity with an instruction from an instruction buffer control unit;
determining whether a branching condition for an instruction issued by a branch determination unit is satisfied;
clearing the branch buffer by the instruction buffer control unit when the branching condition is not satisfied;
specifying an address to be issued next by the instruction buffer control unit as a branching target address when the branching condition is satisfied;
determining, by the instruction buffer control unit, whether there is an instruction in the branch buffer; and
copying and moving the content of the branch buffer to the normal buffer in conformity with an instruction from the instruction buffer control unit, and at the same time selecting, by the to-be-issued selecting unit, an instruction from the branch buffer and issuing the instruction in conformity with an instruction from the instruction buffer control unit when the branching condition is satisfied.

14. The processor instruction buffer operating method of claim 13, further comprising:
fetching, by the instruction buffer control unit, an instruction of a branching target from a memory system and storing the instruction in the normal buffer in conformity with an instruction from the instruction buffer control unit when the branching condition is not satisfied in determining, by the instruction buffer control unit, whether there is an instruction in the branch buffer; and
selecting, by the to-be-issued instruction selecting unit, an instruction from the normal buffer and issuing the instruction in conformity with an instruction from the instruction buffer control unit.

15. The processor instruction buffer operating method of claim 13, further comprising:
incrementing an address to be issued next by the instruction buffer control unit after clearing the branch buffer;
determining whether there is an instruction to be issued next by the instruction buffer control unit in the normal buffer; and
selecting, by the to-be-issued instruction selecting unit, an instruction from the normal buffer and issuing the instruction in conformity with an instruction from the instruction buffer control unit when the branching condition is satisfied.

16. The processor instruction buffer operating method of claim 15, further comprising
fetching from the memory system an instruction to be issued next by the instruction fetch unit and storing the instruction in the normal buffer in conformity with an instruction from the instruction buffer control unit when the branching condition is not satisfied in determining, by the instruction buffer control unit, whether there is an instruction in the normal buffer.

17. A processor instruction buffer operating method, comprising:
selecting, by a to-be-issued instruction selecting unit, an instruction from a normal buffer and a loop buffer and issuing the instruction in conformity with an instruction from an instruction buffer control unit;
determining whether an instruction issued by a loop processing unit is a loop start instruction;
determining whether the loop processing unit initiates jumping from the tail end of a loop to the beginning thereof and a looping condition is satisfied when the branching condition is not satisfied;
jumping to the beginning of the loop and specifying an address to be issued next by the instruction buffer control unit as the loop start address when the branching condition is satisfied; and
copying the content of the loop buffer and storing the content in the normal buffer in conformity with an instruction from the instruction buffer control unit, and at the same time selecting, by the to-be-issued selecting unit, an instruction from the loop buffer and issuing the instruction in conformity with an instruction from the instruction buffer control unit.

18. The processor instruction buffer operating method of claim 17, further comprising
copying and storing an instruction in the normal buffer in the loop buffer in conformity with an instruction from the instruction buffer control unit when the branching condition is satisfied in determining whether an instruction issued by a loop processing unit is a loop start instruction.

19. The processor instruction buffer operating method of claim 17, further comprising:
incrementing an address to be issued next by the instruction buffer control unit when the branching condition is not satisfied in determining whether the loop processing unit initiates jumping from the tail end of a loop to the beginning thereof and a looping condition is satisfied;
determining whether there is an instruction to be issued next by the instruction buffer control unit in the normal buffer; and
selecting, by the to-be-issued instruction selecting unit, an instruction from the normal buffer and issuing the instruction in conformity with an instruction from the instruction buffer control unit when the branching condition is satisfied.

20. The processor instruction buffer operating method of claim 19, further comprising
fetching from a memory system an instruction to be issued next by the instruction fetch unit and storing the instruction in the normal buffer in conformity with an instruction from the instruction buffer control unit when the branching condition is not satisfied in determining whether there is an instruction to be issued next by the instruction buffer control unit in the normal buffer.
